(19) United States
(12) Patent Application Publication
(10) Pub. No.: US 2006/0170488 A1
(43) Pub. Date: Aug. 3, 2006

(54) Reference voltage generation circuit

(75) Inventors: Marc Sabut, Eybens (FR); Jean-Luc Moro, Grenoble (FR)

Correspondence Address: SEED INTELLECTUAL PROPERTY LAW GROUP PLLC, 701 FIFTH AVENUE, SUITE 6300, SEATTLE, WA, 98104-7092, US

(73) Assignee: STMicroelectronics SA, Montrouge (FR)

(21) Appl. No.: 11/340,406

(22) Filed: Jan. 26, 2006

(30) Foreign Application Priority Data
Jan. 26, 2005 (FR) 05/50227

(51) Int. Cl. G05F 1/10

(52) U.S. Cl. 327/538

(57) ABSTRACT

A circuit of generation of a reference voltage by a first MOS transistor of a first type connected to a first terminal of application of a supply voltage. The first transistor is connected with a second MOS transistor of the same type controlled by an input stage of a transconductance amplifier and their junction point defines an output terminal providing the reference voltage. A first current source of fixed value connects the first supply terminal to the gate of the first transistor, a second current source of fixed value connecting the second transistor to a second terminal of application of the supply voltage.

### BACKGROUND OF THE INVENTION

1. Field of the Invention

The present invention generally relates to electronic circuits and more specifically to the generation of reference voltages close to the circuit supply voltages.

An example of application of the present invention relates to analog-to-digital converters and the generation of reference voltages defining the levels of states “0” and “1” of the bits. More generally, the present invention particularly applies as soon as at least one reference voltage close to the level of a supply voltage is desired (for example, digital-to-analog converters and reference circuits for video signals).

2. Description of the Related Art

FIG. 1 is a schematic block diagram of an analog-to-digital converter 1 (ADC) of a type to which the present invention can be applied. Such a converter is supplied by a D.C. voltage Vdd applied between two terminals 2 and 3 of circuit 1. In the example of FIG. 1, converter 1 has differential inputs. A differential signal Vin is applied between two input terminals 4 and 5 of the converter which also receives two reference signals VrefP and VrefM on inputs 6 and 7. Reference signals VrefP and VrefM provide voltage levels around half of the supply voltage, Vdd/2. A sampling frequency is set by a clock signal Clk applied on a clock input 9. Circuit 1 provides a binary signal OUT over n bits on a serial output or several parallel outputs 8.

FIG. 2 illustrates, with a voltage scale, the operation of the converter of FIG. 1. Voltages VrefP and VrefM range between levels Vdd and zero on either side of median level Vdd/2. Difference ΔV between levels VrefP and VrefM defines the converter dynamics. The greater this difference, the better the signal-to-noise ratio of the converter. Interval g+ between voltage Vdd and voltage VrefP and interval g− between voltage VrefM and the ground (zero) are linked to technological constraints of the circuit, as will be seen hereafter.

Inside of converter 1, reference signals VrefP and VrefM are connected to one or several elements operating as current sources which absorb (on level VrefP) or provide (on level VrefM) a current depending on the working frequency of the converter and on the number of stages respectively providing states 0 and states 1.

After, the present invention will be described in relation with the generation of a single reference level VrefP close to positive level Vdd of the supply voltage. It should however be noted that it more generally applies to the generation of positive or negative reference signals, for example, in a differential application. Similarly, for simplification, reference will be made to a negative ground reference, knowing that it may be any positive or negative level smaller than level Vdd.

FIG. 3 schematically shows a conventional example of a circuit for generating a reference voltage VrefP of the type to which the present invention applies. Voltage VrefP is provided by an N-channel MOS transistor MN1, connected between a line 2 for providing voltage Vdd and a current source 11 connected to ground 3. Transistor MN1 and source 11 form the output stage of a transconductance amplifier 10 having a first input 14 receiving, from a resistor R1, a fixed reference voltage VBG linked to the technology (generally called bandgap voltage) and having a second input connected to ground. Internally, the first input is connected to an input amplifier 12(A). Output 13 of the circuit (drain of transistor MN1) is looped back on input 14 by a resistor R2. The respective values of resistors R1 and R2 set the value of level VrefP with respect to level VBG.

The assembly of FIG. 3 is generally called a “follower” and its function is to provide the current necessary to the operation of the circuits connected downstream of terminal 13, while maintaining voltage level VrefP.

In applications where supply voltage Vdd is relatively low (less then 3 volts, typically 2.5 volts), it is difficult to maintain level VrefP close to level Vdd. Indeed, the operation of the follower of FIG. 3 requires a voltage of approximately 600 millivolts, or even 900 millivolts to provide the gate-source voltage of transistor MN1, which imposes the voltage difference between terminal 2 and terminal 13. To this gate-source voltage problem adds the waste voltage of amplifier 12. This results in practice in that voltage level VrefP is around one volt. By applying the same circuit on the side of generation of level VrefM with respect to ground, it can be seen that dynamics of a few hundreds of millivolts is obtained for the converter, which is insufficient in practice. Accordingly, this solution is not adapted to such low supply voltages.

To bring level VrefP closer to level Vdd, the structure of the output stage is generally inverted by connecting a P-channel MOS transistor in series with a current source between terminals 2 and 3. However, this imposes sizing this transistor to the worst operating case of the application since it must stand all the current if the downstream circuit (the converter) does not absorb current.

FIG. 4 shows another conventional example of a follower circuit 20 for generating a reference voltage VrefP for an analog-to-digital converter 1. In FIG. 4, current source 15 to which converter 1 is equivalent for reference voltage VrefP has been illustrated. Input 6 of converter 1 is grounded by an external capacitor Cext (optional) having the function of stabilizing level VrefP. For simplification, only the output stage of the follower amplifier has been shown in FIG. 4. Of course, such an assembly also comprises a feedback (resistor R1 and R2) with input 14 of amplifier 20.

In the example of FIG. 4, a P-channel MOS transistor MP1 is controlled by input amplifier 12 of the assembly and is connected by a current source 21 to terminal 2 of application of voltage Vdd. The fact of transferring the current source to the positive supply side enables avoiding the significant voltage drop linked to the gate-source voltage of the N-channel MOS transistor of FIG. 3. A second current source 22 connects the drain of transistor MP1 to ground 3 and this drain is connected by a third current source 23, mirror-assembled on current source 21. The mirror ratio generally is of one and current source 22 is a fixed current source absorbing the sum of the currents provided by sources 21 and 23. For example, a first P-channel MOS transistor MP2 forming source 21 connects terminal 2 to the source of transistor MP1. Its gate is directly connected to that of a second transistor MP3 forming current source 23 connecting terminal 2 to the drain of transistor MP1, the common gates being further connected to this drain. Such an assembly enables reducing the size of MOS transistor MP1 since it is not permanently crossed by the maximum current (worst case) absorbed by downstream converter 1.

When converter 1 draws current (source 15), amplifier 12 reacts by increasing the gate voltage of transistor MP1. This results in turning off transistor MP1 and mirror transistor MP2 then provides the converter with a current corresponding to the value set by source 21. Conversely, when the converter draws no current, transistor MP1 is on and the fixed current absorbed by source 22 is not only provided by this transistor MP1, but also by transistor MP3.

As compared to the assembly of FIG. 3, the assembly of FIG. 4 enables reaching a voltage VrefP on the order of 2 volts for a voltage Vdd on the order of 2.2 volts (level Vdd decreased by approximately 0.2 volt for the operation of transistor MP2).

By reproducing a similar assembly (based on N-channel transistors) on the negative terminal side (ground 3) of the power supply, a second reference level VrefM at approximately 0.2 volt can be generated, which provides dynamics greater than 1 volt to the converter. Such a dynamics level is acceptable in most cases.

However, a disadvantage of the solution of FIG. 4 is that the current absorbed by source 22 remains independent from the operation of the circuits connected downstream and thus generates a permanent consumption. The efficiency of such a reference voltage generator thus remains low.

### BRIEF SUMMARY OF THE INVENTION

One embodiment of the present invention overcomes all or part of the disadvantages of known reference voltage generators aiming at generating a reference level close to a supply level of the circuit.

One embodiment of the present invention provides a reference voltage generator in which the consumption is adapted to the current required by the downstream-connected circuits.

One embodiment of the present invention also provides a solution compatible with a use in non-differential mode and in differential mode.

One embodiment of the present invention provides a circuit of generation of a reference voltage by a first MOS transistor of a first type connected to a first terminal of application of a supply voltage, said first transistor being in series with a second MOS transistor of the same type controlled by an input stage of a transconductance amplifier and their junction point defining an output terminal providing the reference voltage, a first current source of fixed value connecting said first supply terminal to the gate of the first transistor, a second current source of fixed value connecting the second transistor to a second terminal of application of the supply voltage.

According to an embodiment of the present invention, a third MOS transistor of a type opposite to the first two connects the two current sources.

According to an embodiment of the present invention, the first transistor is sized according to the current likely to be surged or given back by the circuits connected to the output terminal.

According to an embodiment of the present invention, the second transistor is sized according to the fixed value of the current sources.

According to an embodiment of the present invention, the second current source is formed of a second MOS transistor of the second type biased by a fixed signal.

According to an embodiment of the present invention, the first current source is formed of a third transistor of the first type assembled as a current mirror on a fourth transistor of the first type in series with a third transistor of the second type having its gate connected to that of the second transistor of the second type.

According to an embodiment of the present invention, the first transistor of the second type is controlled by a constant signal.

According to an embodiment of the present invention, the circuit generates a reference voltage closer to the voltage of the first terminal than to that of the second terminal, the transistors of the first type being P-channel transistors while the transistors of the second type are N-channel transistors.

According to an embodiment of the present invention, the circuit generates a reference voltage closer to the voltage of the second terminal than to that of the first terminal, the transistors of the first type being N-channel transistors while the transistors of the second type are P-channel transistors.

The foregoing and other features, and advantages of the present invention will be discussed in detail in the following non-limiting description of specific embodiments in connection with the accompanying drawings.

### BRIEF DESCRIPTION OF THE SEVERAL VIEWS OF THE DRAWINGS

FIG. 1, previously described, very schematically shows in the form of blocks an analog-to-digital converter with differential inputs of the type to which the present invention more specifically applies;

FIG. 2, previously described, shows the voltage scale used by the converter of FIG. 1;

FIG. 3, previously described, schematically shows a first conventional example of a reference voltage generation follower assembly;

FIG. 4 shows a second conventional example of a voltage generation follower assembly;

FIG. 5 shows an embodiment of a reference voltage generation circuit according to the present invention;

FIG. 6 is a partially detailed electric diagram of the circuit of FIG. 5; and

FIG. 7 shows annother embodiment of a reference voltage generation circuit according to the present invention.

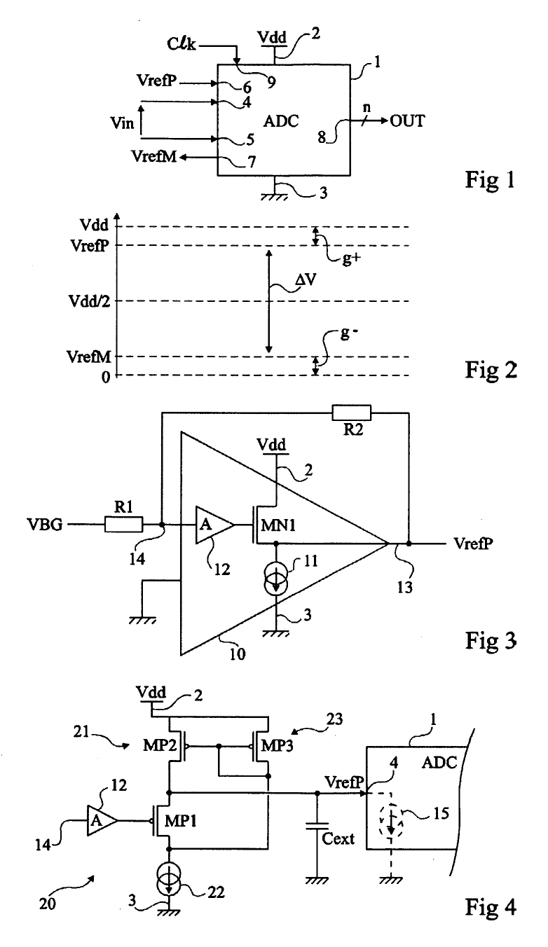

### DETAILED DESCRIPTION OF THE INVENTION

Same elements have been designated with same reference numerals in the different drawings. For clarity, only those elements which are necessary to the understanding of the present invention have been shown in the drawings and will be described hereafter. In particular, the details constitutive of the circuit using reference voltages generated by an assembly of the present invention (for example, an analog-to-digital converter) have not been detailed, the present invention generating no modification of the circuits connected downstream of the reference voltage generation circuit.

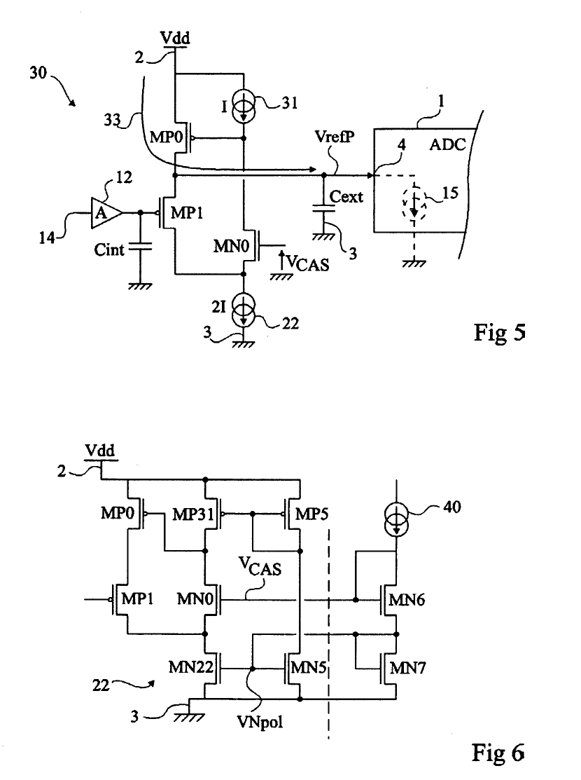

FIG. 5 partially and schematically shows an embodiment of a circuit 30 forming a follower assembly of generation of a positive voltage VrefP according to the present invention. This voltage is, for example, intended for an analog-to-digital conversion circuit 1 (ADC) having an input terminal 6 of positive reference level connected to ground 3 by an external capacitor Cext (optional).

As in the previous solution of FIG. 4, an input amplifier 12(A) receiving a reference level (for example, a bandgap-type voltage) from a resistor (not shown) controls a P-channel MOS transistor MP1 having its source providing voltage VrefP. A capacitor Cint grounds the gate of transistor MP1 to stabilize the assembly.

The source of transistor MP1 is connected to a terminal 2 of application of voltage Vdd by a P-channel MOS transistor MP0 having its gate connected to terminal 2 by a current source 31. Conversely to the assembly of FIG. 4, current source 31 provides a fixed current I, and the transistor forming this current source is thus not mirror-assembled on transistor MP0. A second fixed current source 22 connects the drain of transistor MP1 to ground 3 and an N-channel MOS transistor MN0 connects the gate of transistor MP0 (output of source 31) to the drain of transistor MP1. The function of transistor MN0 is to set the drain voltage of transistor MP1 with respect to ground 3, which amounts to making this drain level independent from the gate voltage of transistor MP0 to enable operation of transistor MP1. Source 31 of fixed value is, preferably, a current mirror of source 22. Transistor MN0 is controlled by a voltage signal VCAS, the generation of which will be described hereafter in relation with FIG. 6. This voltage is a constant voltage since transistor MN0 is always on. It is selected to be greater than the saturation drain-source voltage of the transistor forming source 22 plus the gate-source voltage drop VGS of transistor MN0.

When converter 1 draws current (by its current source 15 on terminal 4), amplifier 12 reacts by increasing the gate voltage of transistor MP1. The gate voltage increase of transistor MP1 results in turning off this transistor and a current then flows through transistor MP0 to provide the current surged by converter 1 (arrow 33 in FIG. 5). Transistor MP0 (like transistor MP2 of FIG. 4) preferably is sized according to the worst case of the application to be able to convey the current surged by the downstream circuits. The gate of transistor MP0 is discharged by current source 22. The discharge current of this gate corresponds to the difference (for example, 2I-I) of the fixed currents of sources 22 and 31. The discharge of the gate of transistor MP0 results in increasing the current that it provides.

When converter 1 surges no current, transistor MP1 is turned on by amplifier 12. The idle current thus consumed corresponds to current I.

The values of current sources 31 and 22 are selected to be as small as possible, knowing that the greater the current, the faster the system charges and discharges the gate capacitance of transistor MP0. Since this transistor is sized for the worst case of the application, this gate capacitance conditions the sizes of respective current sources 31 and 22.

According to an alternative embodiment where external capacitor Cext is omitted, current sources 31 and 22 may be greater, to preserve the rapidity of the system.

Dynamically, when reference voltage VrefP tends to fall under the effect of a greater current absorbed by circuit 1, the gate voltage of transistor MP0 tends to decrease since current I is imposed by source 31. The decrease in the gate voltage is linked to providing current 2I of source 22. As a result, transistor MP0 lets through more current and thus recovers its equilibrium. At equilibrium, the respective currents in transistors MP0 and in source 31 are both equal to value I (half the level set by source 22). When the equilibrium is broken, the more the converter draws current, the more the gate voltage of transistor MP0 decreases. Its gate-source voltage, and thus the current that it provides, is thus set.

An advantage is that whatever the operating frequency of converter 1 and the number of states 0 and 1 to be generated, the generator adapts to the surged current.

Another advantage is that the quiescent current is minimized.

Another advantage induced by the assembly 30 is that the circuit remains stable, be it with or without external capacitor Cext.

In conventional assemblies, the stability of reference voltage VrefP is linked to capacitance Cext which is used as a charge tank or capacitance Cint. However, the designer must choose between one or the other of these capacitances to provide the system stability, failing which said system oscillates.

Conversely, the stability of the circuit is only set by capacitance Cint and is independent from external capacitance Cext. Accordingly, the reference voltage generator 30, may be used with or without an external capacitance, without for the designer to need to define this point in advance.

In the looped-back system (resistor R1 and R2, FIG. 3) between point 14 and terminal 4, the dominant pole is now only linked to capacitance Cint, especially if the latter has a significant value (typically, several picofarads).

FIG. 6 shows a partial detailed electric diagram illustrating an embodiment of current sources 31 and 22 as well as of the generation of signal VCAS according to one embodiment of the present invention.

Current source 22 is formed of an N-channel MOS transistor MN22 connecting the drain of transistor MP1 to ground 3. The gate of transistor MN22 receives a biasing signal VNpol. This signal corresponds to the biasing signal usually generated to bias all the N-channel transistors of the circuit and can be found in all conventional systems.

Current source 31 is formed of a P-channel MOS transistor MP31 connecting terminal 2 to the gate of transistor MP0. To set the ratio between current I of source MP31 and that 21 of source MN22 in fixed fashion, transistor MP31 is assembled as a current mirror on a transistor MP5, itself in series with an N-channel MOS transistor MN5 between terminals 2 and 3. Transistor MN5 has its gate connected to that of transistor MN22 while transistor MP5 has its gate connected to its drain and to the gate of transistor MP31. The ratio between respective currents I and 2I of sources 31 and 22 is set by the surface area ratio between transistors MP5 and MP31. Assuming that transistors MN5 and MN22 both have the same size, a transistor MP5 of double size as compared to that of transistor MP31 sets a ratio of two between sources 22 and 31.

Signals VCAS and VNpol are provided, for example, by two diode-assembled N-channel transistors MN6 and MN7 series-connected between a current source 40 and the ground, source 40 providing a constant current or a current adapted to temperature. The gates of transistors MN6 and MN7 are connected to the respective gates of transistors MN0 and MN22.

An advantage of the assembly 30 is that it employs a single transistor (MP0) sized to stand all the current of the application. Another advantage is that the current absorbed by the downstream circuits is independent from the currents consumed by the control structure. Accordingly, the idle system consumption is reduced.

Another advantage is that it is compatible with the generation of reference voltages close to the supply levels, adapted in particular to the generation of reference levels for analog-to-digital converters.

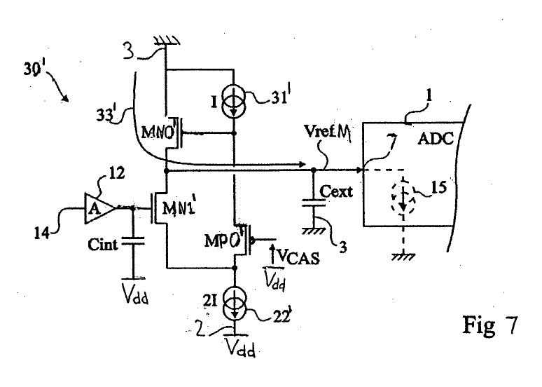

Of course, the present invention is likely to have various alterations, modifications, and improvements which will readily occur to those skilled in the art. In particular, the transposition of the described reference circuit to the generation of a reference voltage with respect to ground from a dual assembly, by replacing the N-channel transistors with P-channel transistors and conversely, is within the abilities of those skilled in the art based on the functional indications given hereabove and is shown in the embodiment of FIG. 7. Further, the respective dimensions to be given to the different transistors according to the application are also within the abilities of those skilled in the art.

FIG. 7 partially and schematically shows an embodiment of a circuit 30′ forming a follower assembly of generation of a positive voltage VrefM according to the present invention. This voltage is, for example, intended for the analog-to-digital conversion circuit 1 (ADC) having an input terminal 7 of positive reference level connected to ground 3 by an external capacitor Cext (optional).

In FIG. 7, an input amplifier 12(A) receiving a reference level (for example, a bandgap-type voltage) from a resistor (not shown) controls an N-channel MOS transistor MN1′ having its source providing voltage VrefM. A capacitor Cint connects to Vdd the gate of transistor MP1 to stabilize the assembly.

The source of transistor MN1′ is connected to a ground terminal 3 by an N-channel MOS transistor MN0′ having its gate connected to terminal 3 by a current source 31′. Conversely to the assembly of FIG. 4, current source 31′ provides a fixed current I, and the transistor forming this current source is thus not mirror-assembled on transistor MN0′. A second fixed current source 22′ connects the drain of transistor MN1′ to Vdd 2 and a P-channel MOS transistor MP0′ connects the gate of transistor MN0′ (output of source 31′) to the drain of transistor MN1′. The function of transistor MP0′ is to set the drain voltage of transistor MN1′ with respect to Vdd 2, which amounts to making this drain level independent from the gate voltage of transistor MN0′ to enable operation of transistor MN1′. Source 31′ of fixed value is, preferably, a current mirror of source 22′. Transistor MP0′ is controlled by a voltage signal VCAS′, the generation of which will be appreciated based on the above discussion of the generation of voltage signal VCAS. This voltage is a constant voltage since transistor MP0′ is always on.

Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

What is claimed is:

1. A circuit of generation of a reference voltage, the circuit comprising:
a MOS first transistor of a first type connected to a first supply terminal of application of a supply voltage;
a MOS second transistor of the first type, connected to the first transistor at a junction point defining an output terminal providing the reference voltage;
an input stage of a transconductance amplifier, the input stage controlling the second transistor;
a first current source of fixed value connecting said first supply terminal to a gate of the first transistor; and
a second current source of fixed value connecting the second transistor to a second supply terminal of application of the supply voltage.

2. The circuit of claim 1, wherein a MOS third transistor of a second type opposite to the first type connects the two current sources to each other.

3. The circuit of claim 2, wherein the third transistor is controlled by a constant signal.

4. The circuit of claim 1, wherein the first transistor is sized according to a current likely to be sinked or provided by circuits connected to the output terminal.

5. The circuit of claim 1, wherein the second transistor is sized according to the fixed value of the current sources

6. The circuit of claim 1, wherein the second current source is formed of a MOS third transistor of a second type, opposite to the first type, and biased by a fixed signal.

7. The circuit of claim 6, wherein the first current source is formed of a fourth transistor of the first type assembled as a current mirror with a fifth transistor of the first type connected with a sixth transistor of the second type having a gate connected to a gate of the third transistor.

8. The circuit of claim 1, wherein the first and second transistors are sized such that the reference voltage is closer to a voltage of the first supply terminal than to a voltage of the second supply terminal, the first and second transistors being P-channel transistors.

9. The circuit of claim 1, wherein the first and second transistors are sized such that the reference voltage is closer to a voltage of the second supply terminal than to a voltage of the first supply terminal, the first and second transistors being N-channel transistors.

10. A reference voltage generation circuit that generates a reference voltage, the circuit comprising:
a first transistor connected to a first voltage terminal;
a second transistor connected between the first voltage terminal and a second voltage terminal, the second transistor being connected to the first transistor at a first junction point defining an output terminal providing the reference voltage;
a first current source connecting the first voltage terminal to a control terminal of the first transistor;
a second current source connecting the second transistor to the second voltage terminal; and
a third transistor connecting the control terminal of the first transistor to a second junction point between the second transistor and the second current source.

11. The circuit of claim 10, wherein the first and second transistors are MOS transistors of a first conductivity type and the third transistor is a MOS transistor of a second conductivity type opposite to the first conductivity type.

12. The circuit of claim 11, wherein the third transistor is controlled by a constant signal.

13. The circuit of claim 10, wherein the second current source is formed of a fourth transistor connected between the second transistor and the second voltage terminal, the first and second transistors being of a first conductivity type and the fourth transistor being of a second conductivity type, opposite to the first conductivity type.

14. The circuit of claim 10, wherein the first current source is formed of a fourth transistor assembled as a current mirror with a fifth transistor and the second current source is formed of a sixth transistor assembled as a current mirror with seventh transistor that is connected between the fifth transistor and the second voltage terminal.

15. The circuit of claim 10, wherein the first and second transistors are sized such that the reference voltage is closer to a voltage of the first voltage terminal than to a voltage of the second voltage terminal, the first and second transistors being P-channel transistors.

16. The circuit of claim 10, wherein the first and second transistors are sized such that the reference voltage is closer to a voltage of the second voltage terminal than to a voltage of the first voltage terminal, the first and second transistors being N-channel transistors.

17. A circuit, comprising:
an analog-digital converter having a first input for receiving a first reference voltage; and
a first reference voltage generator that generates the first reference voltage, the first reference voltage generator including:
a MOS first transistor of a first type connected to a first supply terminal of application of a supply voltage;
a MOS second transistor of the first type, connected to the first transistor at a junction point defining an output terminal providing the first reference voltage;
an input stage of a transconductance amplifier, the input stage controlling the second transistor;
a first current source of fixed value connecting said first supply terminal to a gate of the first transistor; and
a second current source of fixed value connecting the second transistor to a second supply terminal of application of the supply voltage.

18. The circuit of claim 17, wherein first reference voltage generator includes a MOS third transistor, of a second type opposite to the first type, that connects the two current sources to each other.

19. The circuit of claim 17, wherein the second current source is formed of a MOS third transistor of a second type, opposite to the first type, and biased by a fixed signal.

20. The circuit of claim 19, wherein the first current source is formed of a fourth transistor of the first type assembled as a current mirror with a fifth transistor of the first type connected with a sixth transistor of the second type having a gate connected to a gate of the third transistor.

21. The circuit of claim 17, wherein the first and second transistors are sized such that the first reference voltage is closer to a voltage of the first supply terminal than to a voltage of the second supply terminal, the first and second transistors being P-channel transistors.

22. The circuit of claim 17, wherein the analog-digital converter has a second input for receiving a second reference voltage, the circuit further comprising:
a second reference voltage generator that generates the second reference voltage, the second reference voltage generator including:
a MOS third transistor of the second type connected to the second supply terminal;
a MOS fourth transistor of the second type, connected to the third transistor at a junction point defining an output terminal providing the second reference voltage;
a third current source of fixed value connecting the second supply terminal to a gate of the third transistor; and
a fourth current source of fixed value connecting the fourth transistor to the first supply terminal.

23. A circuit, comprising:
an analog-digital converter having a first input for receiving a first reference voltage; and
a first reference voltage generator that generates the first reference voltage, the first reference voltage generator including:
a first transistor connected to a first voltage terminal;
a second transistor connected between the first transistor and a second voltage terminal, the second transistor being connected to the first transistor at a first junction point defining an output terminal providing the first reference voltage;
a first current source connecting the first voltage terminal to a control terminal of the first transistor;
a second current source connecting the second transistor to the second voltage terminal; and
a third transistor connecting the control terminal of the first transistor to a second junction point between the second transistor and the second current source.

24. The circuit of claim 23, wherein the first and second transistors are MOS transistors of a first conductivity type and the third transistor is a MOS transistor of a second conductivity type opposite to the first conductivity type.

25. The circuit of claim 23, wherein the second current source is formed of a fourth transistor connected between the second transistor and the second voltage terminal, the first and second transistors being of a first conductivity type and the fourth transistor being of a second conductivity type, opposite to the first conductivity type.

26. The circuit of claim 23, wherein the first current source is formed of a fourth transistor assembled as a current mirror with a fifth transistor and the second current source is formed of a sixth transistor assembled as a current mirror with seventh transistor that is connected between the fifth transistor and the second voltage terminal.

27. The circuit of claim 23, wherein the first and second transistors are sized such that the reference voltage is closer to a voltage of the first voltage terminal than to a voltage of the second voltage terminal, the first and second transistors being P-channel transistors.

28. The circuit of claim 23, wherein the analog-digital converter has a second input for receiving a second reference voltage, the circuit further comprising:
a fourth transistor connected to the second voltage terminal;
a fifth transistor connected between the fourth transistor and the first voltage terminal, the fifth transistor being connected to the fourth transistor at third first junction point defining an output terminal providing the second reference voltage;
a third current source connecting the second voltage terminal to a control terminal of the fourth transistor;
a fourth current source connecting the fifth transistor to the first voltage terminal; and
a sixth transistor connecting the control terminal of the fourth transistor to a fourth junction point between the fifth transistor and the fourth current source.
